(19) United States
(12) Patent Application Publication
(10) Pub. No.: US 2005/0064916 A1
(43) Pub. Date: Mar. 24, 2005

(54) User cognitive electronic device

(75) Inventors: Fatih Ozluturk, Port Washington, NY (US); Alain Charles Louis Briancon, Poolesville, MD (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/726,372

(22) Filed: Dec. 3, 2003

Related U.S. Application Data
(60) Provisional application No. 60/506,079, filed on Sep. 24, 2003.

(51) Int. Cl. H04M 1/00

(52) U.S. Cl. 455/575.1

(57) ABSTRACT

An electronic device receives user inputs. The user inputs indicating interactions of the user with processing of the electronic device. The device determines interaction patterns of the user with the device. The device uses the determined interaction patterns to determine adjustments for the electronic device. The electronic device is adjusted using the determined adjustments.

### CROSS REFERENCE TO RELATED APPLICATION(S)

This application claims priority from U.S. provisional application No. 60/506,079 filed on Sep. 24, 2003 which is incorporated by reference as if fully set forth.

### FIELD OF INVENTION

This invention generally relates to electronic devices. In particular, this invention relates to user interaction with such devices.

### BACKGROUND

Electronic devices, such as personal digital assistants (PDAs), cellular phones, computers, etc., have been increasing in use. In the past, these devices were primarily used for work. Presently, these devices are used in all aspects of users' lives, work, leisure, recreation, etc.

Although the ease of use of these devices has generally increased, in many instances, these devices are still cumbersome and awkward to use. The desire for added features and functionality in smaller footprint devices adds to these problems.

To illustrate, on a traditional wired telephone set, to end a call, the handset is returned to its cradle automatically terminating a call. In a typical cellular phone, to end a call, a small button is typically depressed. Frequently, a user accustomed to using a traditional handset will forget to terminate the call by depressing the button or will not fully depress or hit a wrong button on a small keypad. The user may have the embarrassing experience of having the call recipient listen to the user's subsequent conversations. Additionally, the additional wireless connect time could cost the user additional money.

Accordingly, it is desirable to increase the ease of use of wireless devices.

### SUMMARY

An electronic device receives user inputs. The user inputs indicating interactions of the user with processing of the electronic device. The device determines interaction patterns of the user with the device. The device uses the determined interaction patterns to determine adjustments for the electronic device. The electronic device is adjusted using the determined adjustments.

### BRIEF DESCRIPTION OF THE DRAWING(S)

FIG. 1 is a flow chart for a user cognitive electronic device.

FIG. 2 is a simplified block diagram of a user cognitive electronic device.

FIG. 3 is a simplified block diagram of a user cognitive wireless transmit/receive unit.

FIG. 4 is a flow chart for a multiple user cognitive electronic device.

### DETAILED DESCRIPTION OF THE PREFERRED EMBODIMENT(S)

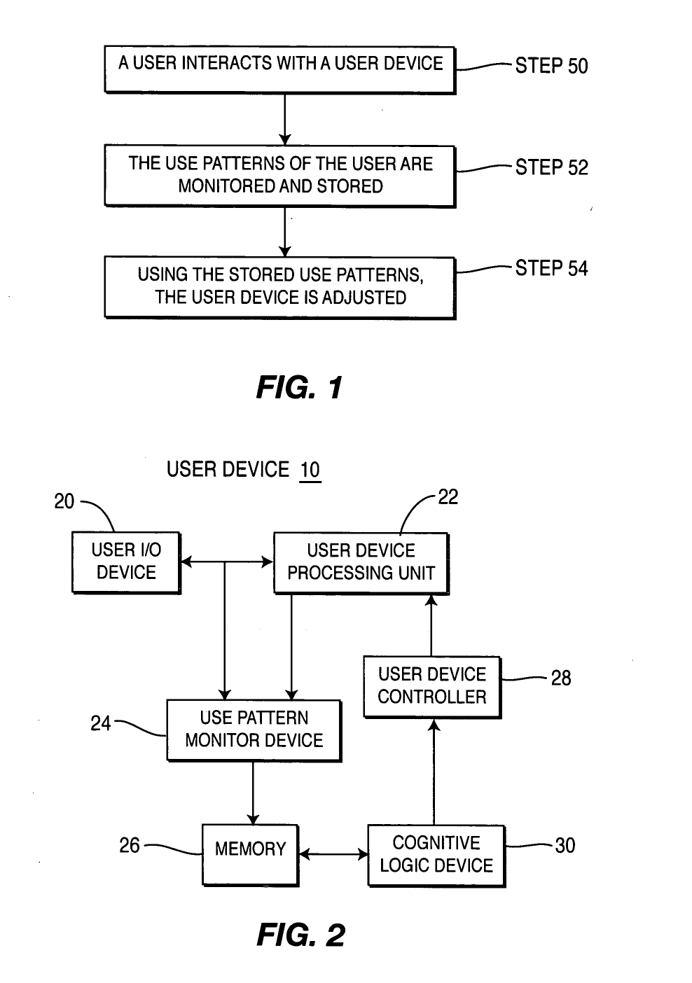

FIG. 1 is a flow chart and FIG. 2 a simplified block diagram of a user cognitive electronic device. The user cognitive electronic device can be any electronic device, such as a personal digital assistant (PDA), computer or wireless transmit/receive unit (WTRU). Hereafter, a WTRU includes but is not limited to a user equipment, mobile station, fixed or mobile subscriber unit, pager, or any other type of device capable of operating in a wireless environment.

A user interacts with the electronic device (user device 10) using an input/output (I/O) device 20, such as a keypad, keyboard, mouse, touchpad, stylus, monitor and LCD display, step 50. A user device processing unit 22 receives the user inputs and performs corresponding functions in response to the inputs. Examples of user processing devices 22 are computer processing units (CPUs), reduced instruction set (RISC) processors, digital signal processors (DSPs), among others as well as combinations of these. A user pattern monitor device 22 monitors the user interactions and stores them into an associated memory 26, step 52. The possible types of memory used as the associated memory 26 include but are not limited to RAM, ROM, disk storage, virtual, memory stick, flash, remote memory, such as network memory and a combination of these, among others. This memory 26 may be a memory shared with the user device processing unit 22.

A cognitive logic device 30 analyzes the user interaction patterns (user behavior) and identifies adjustments for the processing device 22. These adjustments may include changing user device processing unit parameters, configurations or states. The cognitive model detects patterns in the user's behavior, creates a rule based on the pattern and applies the rule. The rules can be added, changed and/or expire. Certain rules may also have priority over other rules.

To illustrate, if the user frequently forgets to terminate a telephone call by pressing a corresponding button on a keypad, the device may shorten the time out timer setting and turn off the display and call counter faster. Such an adjustment may save the user money as a result of decreased wireless connect time and possible embarrassment.

Another illustration is that a user may have a tendency to send a picture almost every time a particular telephone number is called. The electronic device may display the stored picture menu automatically when that number is called. Another illustration is a user may increase the volume of a WTRU every time a hands-free unit is connected to the WTRU. When the WTRU detects that the hands-free unit is connected, the volume is automatically raised. When the WTRU detects the hands-free unit is being disconnected, the volume is automatically lowered.

The adjustments determined by the cognitive logic device 30 are used by a user device controller 28 to adjust the parameters, configurations and states of the user device processing unit 22, step 54. Preferably, the user can turn off all the rules of the cognitive model or portions of the rules, via the user I/O device 20. The components, as illustrated in FIG. 2, may be implemented on a single integrated circuit, discrete components or a combination.

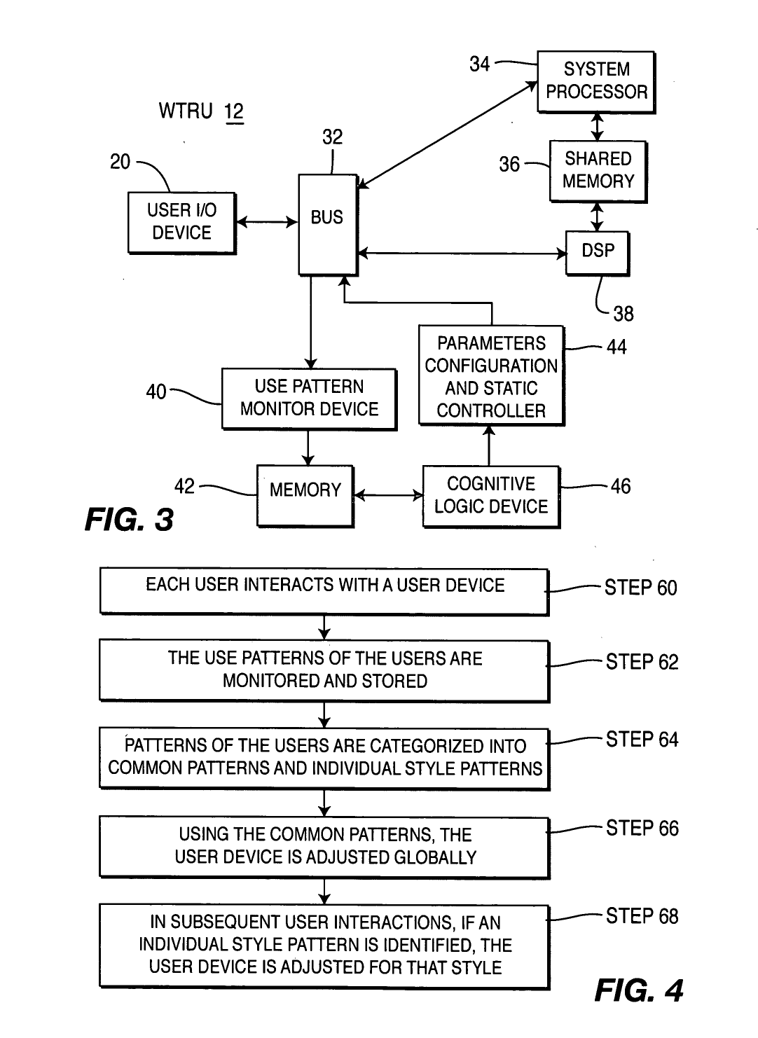

FIG. 3 is an embodiment of a user cognitive WTRU 12. Although the WTRU 12 is illustrated with one system architecture, others may be used. The user input is received by a user I/O device 20. The user inputs are passed to the WTRU's processors, such as by a common bus 32. The WTRU's processors are illustrated in FIG. 3 as being a system processor 34, such as a RISC processor, and a DSP 38, communicating with each other using a shared memory 36 and a bus 32. The WTRU processors perform various functions in response to the user inputs.

A user pattern monitor device 40 monitors the user interactions and stores them into an associated memory 42. This memory 42 may be the same memory as the shared memory 36. A cognitive logic device 30 analyzes the user interaction patterns (user behavior) and identifies adjustments for the WTRU processors. A parameter, configuration and state controller makes adjustments to the WTRU processors in response to the identified adjustments. The components, as illustrated in FIG. 3, may be implemented on a single integrated circuit, discrete components or a combination.

User pattern monitor device 40 is able to detect and monitor signals that are generated on the bus 32 as a result of user interaction with the user I/O device 12. The user pattern monitor device 40 may be such that it looks for presence of certain signals and ignore others, or observes all signals. In a typical embodiment, the monitor device 40 will look for presence of a set of signals (i.e. user interactions) and record the frequency (repetitiveness) of those signals as well as the state of various device parameters when that signal occurs. A set of thresholds applied to the frequency of that signal may classify the signal to be at one of various levels of predictability. As the frequency of the signal is updated by every use and the corresponding WTRU device parameters are recorded, use pattern monitor device 40 forms a correlation and indicates the strength of that correlation by a predictability factor.

The information that the monitoring device 40 processes is accessible to the cognitive logic device 46 via the shared memory 42. Cognitive logic device 46 analyzes the information that is gathered and makes decisions. Cognitive device 46 looks at the predictability factor that is calculated by the monitoring device 40 and detects the change in the WTRU device parameters that is associated with the particular signal. Once the predictability factor reaches a certain prestored or calculated level, the cognitive device 46 classifies the presence of the particular signal and the corresponding parameter set as a ‘rule’. In other words, it establishes and records a mapping between the occurrence of the signal and the change in WTRU parameters. Once a rule is established, every time the corresponding signal is detected and reported by the monitoring device 40, the cognitive device 46 will automatically change the WTRU parameters (e.g. timeout timer, volume level, display brightness, list of phone numbers displayed, etc). Cognitive device 46 is such that it continues to evaluate the information from the monitoring device 40 and if the predictability factor becomes lower than the certain prestored or calculated value, it can erase or change a ‘rule’. Therefore the ‘rules’ are not static but they change dynamically as use patterns change.

The method of FIG. 1 can also be applied to multiple users. If each user is identifiable, such as by a different login, a separate user pattern profile can be generated for each user. Accordingly, the cognitive model can be applied differently based on each user's patterns. FIG. 4 is a flow chart for a multiple user cognitive device, where each user is not separately identified. Each of the users interacts with the cognitive user device, step 60. The use patterns are monitored and stored, step 62.

The use patterns are categorized into common use patterns and individual style patterns, step 64. Common use patterns are use patterns that seem prevalent at all times, regardless of the user. Individual style use patterns are reoccurring use patterns that change periodically, indicative of differing users. The use of the individual style patterns attempts to identify the styles of differing users. To illustrate, difference users may be distinguished by their preferred settings for a display of the cognitive user device or by a preferred volume level.

The cognitive model applies the common patterns globally, step 66. The individual style patterns are applied only when that style is identified, based on the current user interactions. The electronic device is adjusted in response to the identified style, step 68. To illustrate, all of the users of a WTRU may increase the volume of the WTRU when the hands-free unit is added. The cognitive model may increase the volume at all times that the hands-free unit is added. By contrast, different users may tend to call different telephone numbers. The WTRU may identify a different style used by a user that tends to call a certain telephone number. When the WTRU realizes that the certain number is called, the volume may be automatically changed to a volume level associated with that style. If one style seems to be more prevalently used than other styles, the cognitive model may use that style as the default style and change to another style, if that style is identified.

1. An electronic device comprising:
a user input device for receiving input from a user;
a user device processing unit for performing functions of the electronic device;
a use pattern monitoring device for monitoring use patterns of the user and an associated memory for storing use pattern information;
a cognitive logic device for determining adjustments to the user device processing unit based on the use pattern information; and
a user device processing unit controller for adjusting the user device processing unit in response to the determined adjustments.

2. The electronic device of claim 1 wherein the determined adjustments include changes to parameters, configurations and states of the user device processing unit.

3. The electronic device of claim 1 wherein the cognitive logic device uses a cognitive model that creates rules based on an observed interactions of the user.

4. The electronic device of claim 3 wherein the user device unit controller selectively turns off rules in response to user interaction through the user input device.

5. The electronic device of claim 1 wherein the cognitive logic device categorizes the use pattern information into either common interaction patterns or style interaction patterns and adjusting the electronic device based on the common interaction patterns and selectively adjusting the electronic device based on the style interaction patterns in response to a current user interaction style.

6. A wireless transmit/receive unit (WTRU) comprising:
a user input device for receiving input from a user;
a processing unit for performing functions of the electronic device;
a use pattern monitoring device for monitoring use patterns of the user and an associated memory for storing use pattern information;
a cognitive logic device for determining adjustments to the processing unit based on the use pattern information; and
a processing unit controller for adjusting the processing unit in response to the determined adjustments.

7. The WTRU of claim 6 wherein the processing unit comprises a digital signal processor (DSP) and a reduced instruction set (RISC) processor.

8. The WTRU of claim 6 wherein the determined adjustments include changes to parameters, configurations and states of the processing unit.

9. The WTRU of claim 6 wherein the cognitive logic device uses a cognitive model that creates rules based on an observed interactions of the user.

10. The WTRU of claim 6 wherein the processing unit controller selectively turns off rules in response to user interaction through the user input device.

11. An electronic device comprising:
a user input device for receiving input from a user;
a user device processing unit for performing functions of the electronic device;
a use pattern monitoring device for monitoring use patterns of the user and an associated memory for storing use pattern information;
a cognitive logic device for determining adjustments to the user device processing unit based on the use pattern information; and
a user device processing unit controller for adjusting the user device processing unit in response to the determined adjustments.

12. An integrated circuit comprising:
an input configured to receive input from a user;
a processing unit, coupled to the input, for performing functions of an electronic device;
a use pattern monitoring device, coupled to the processing unit, for monitoring use patterns of the user;
an associated memory for storing use pattern information;
a cognitive logic device, coupled to the associated memory, for determining adjustments to the user device processing unit based on the use pattern information; and
a processing unit controller, coupled to the cognitive logic device and processing unit, for adjusting the user device processing unit in response to the determined adjustments.

13. A method for use with an electronic device, the electronic device performing steps comprising:
receiving user inputs at the electronic device indicating interactions of the user with processing of the electronic device;
determining interaction patterns of the user with the electronic device;
using the determined interaction patterns, determining adjustments for the electronic device; and
adjusting the electronic device using the determined adjustments.

14. The method of claim 13 wherein the determined adjustments include changes to parameters, configurations and states of a processing unit.

15. The method of claim 13 wherein the determining adjustments uses a cognitive model that creates rules based on an observed interactions of the user.

16. The method of claim 15 further comprising selectively turning off rules in response to user interaction through the user input device.

17. The method of claim 13 wherein the determining interaction patterns comprises categorizing the use pattern information into either common interaction patterns or style interaction patterns and the electronic device is adjusted based on the common interaction patterns and selectively adjusted based on the style interaction patterns in response to a current user interaction style.

18. A method for use with an electronic device, the electronic device performing steps comprising:
receiving user inputs from a plurality of users at the electronic device indicating interactions of the users with processing of the electronic device;
determining interaction patterns of the users with the electronic device;
categorizing the determined interaction patterns as either common interaction patterns or style interaction patterns;
based on the determined interaction patterns, determining adjustments for the electronic device;
categorizing the determined adjustments as either common adjustments or style adjustments; and
adjusting the electronic device using the common adjustments and selectively applying the style adjustments in response to a current user interaction style.
